(19) United States
(12) Patent Application Publication
(10) Pub. No.: US 2017/0252720 A1
(43) Pub. Date: Sep. 7, 2017

(54) MODIFICATION OF ZEOLITIC IMIDAZOLATE FRAMEWORKS AND AZIDE CROSS-LINKED MIXED-MATRIX MEMBRANES MADE THEREFROM

(71) Applicants: Ihab N. ODEH, Sugar Land, TX (US); Yunyang LIU, Thuwal (SA); Lei SHAO, Thuwal (SA); SABIC Global Technologies B.V., Bergen op Zoom (NL)

(72) Inventors: Ihab N. Odeh, Sugar Land, TX (US); Yunyang Liu, Thuwal (SA); Lei Shao, Thuwal (SA)

(21) Appl. No.: 15/319,242

(22) PCT Filed: Jun. 9, 2016
(86) PCT No.: PCT/US2016/036712

§ 371 Date: Dec. 15, 2016

Related U.S. Application Data
(60) Provisional application No. 62/187,671, filed on Jul. 1, 2015.

(51) Int. Cl. B01J 20/22; B01D 67/00; B01D 71/64; B01D 53/22; C08K 5/56; B01J 20/28; B01J 20/30; C07F 3/06; C08G 73/10; C08J 3/24; B01D 69/14; B01J 20/26

(52) U.S. Cl. CPC B01J 20/226; B01D 69/148; B01D 67/0079; B01D 71/64; B01D 53/228; B01J 20/267; B01J 20/28033; B01J 20/28038; B01J 20/2804; B01J 20/3078; B01J 20/3085; C07F 3/06; C08G 73/1067; C08J 3/247; C08K 5/56; B01D 2323/30; C08J 2379/08

(57) ABSTRACT

Disclosed is a method of modifying a metal-organic framework (MOF), the modified MOF, and methods for using the same. The method of modification can include heating a mixture comprising an azide compound and a MOF to generate a nitrene compound and nitrogen (N2) from the azide compound and covalently bonding the nitrene compound to the MOF to obtain the modified MOF.

### CROSS REFERENCE TO RELATED APPLICATIONS

This application claims the benefit of priority of U.S. Provisional Patent Application No. 62/187,671, filed Jul. 1, 2015, which is hereby incorporated by reference in its entirety.

### BACKGROUND OF THE INVENTION

A. Field of the Invention

The invention generally concerns modified metal-organic frameworks (MOFs) and their use in mixed matrix membranes. In particular, the invention relates to the use of nitrene intermediates to functionalize MOFs, link the functionalized MOFs to polymeric material, and cross-link the polymeric material with the nitrene intermediates to form mixed matrix membranes. The modification of the MOFs and formation of the membranes can be performed in situ.

B. Description of Related Art

A membrane is a structure that has the ability to separate one or more materials from a liquid, vapor or gas. The membrane acts like a selective barrier by allowing some material to pass through (i.e., the permeate or permeate stream) while preventing others from passing through (i.e., the retentate or retentate stream). This separation property has wide applicability in both the laboratory and industrial settings in instances where it is desirable to separate materials from one another (e.g., removal of nitrogen or oxygen from air, separation of hydrogen from gases like nitrogen and methane, recovery of hydrogen from product streams of ammonia plants, recovery of hydrogen in oil refinery processes, separation of methane from the other components of biogas, enrichment of air by oxygen for medical or metallurgical purposes, enrichment of ullage or headspace by nitrogen in inerting systems designed to prevent fuel tank explosions, removal of water vapor from natural gas and other gases, removal of carbon dioxide from natural gas, removal of H₂S from natural gas, removal of volatile organic liquids (VOL) from air of exhaust streams, desiccation or dehumidification of air, etc.).

Examples of membranes include polymeric membranes such as those made from polymers, liquid membranes (e.g., emulsion liquid membranes, immobilized (supported) liquid membranes, molten salts, etc.), and ceramic membranes made from inorganic materials such as alumina, titanium dioxide, zirconia oxides, glassy materials, etc.

For gas separation applications, the membrane of choice is typically a polymeric membrane. One of the issues facing polymeric membranes, however, is their well-known trade-off between permeability and selectivity as illustrated by Robeson's upper bound curves (Robeson, J Membr. Sci. 1991, 62:165; Robeson, J Membr. Sci., 2008, 320:390-400). In particular, there is an upper bound for selectivity of, for example, one gas over another, such that the selectivity decreases with an increase in membrane permeability.

Metal-organic frameworks (MOFs) such as zeolitic imidazolate frameworks (ZIFs) have been previously incorporated into polymeric membranes to create mixed matrix membranes. The purpose of the use of MOFs was to increase the permeability of said membranes. These mixed matrix membranes were prepared by blending ZIFs with polymers, in which no chemical reaction between the ZIFs and the polymers occurred. This allowed for an increase in the permeability of the membranes, due to the poor interaction between the ZIFs and polymers at the polymer-zeolite interface. In particular, non-selective interfacial voids were introduced in the membranes such that the voids allowed for increased permeability but decreased selectivity of given materials. This has been referred to as a “sieve-in-a-cage” morphology (Hillock et al., Journal of Membrane Science. 2008, 314:193-199).

Such “sieve-in-a-cage” morphology has resulted in mixed matrix membranes that fail to perform above a given Robeson upper bound trade-off curve. That is, a majority of such membranes fail to surpass the permeability-selectivity tradeoff limitations, thereby making them less efficient and more costly to use. As a result, additional processing steps may be required to obtain the level of gas separation or purity level desired for a given gas.

In an effort to address the problems associated with the “sieve-in-a-cage” morphology and resulting decrease in selectivity, attempts have been made to crosslink the polymers in the membrane (e.g., by functionalization of the polymers), covalently attach the MOFs to the membrane through functionalization processes, or both. One of the issues with polymer cross-linking processes is the additional materials and energy needed to implement cross-linking.

As for post synthetic functionalization of MOFs, the currently accepted processes are largely based on the use of (1) predesigned ligands in the MOFs that have specific functional groups (e.g., OH, CHO, etc.) (see Jiang et al., Pore Surface Engineering with Controlled Loadings of Functional Groups via Click Chemistry in Highly Stable Metal-Organic Frameworks, J. Am. Chem. Soc. 134 (2012) 14690-14693) or (2) coordinatively unsaturated metal cation sites of the MOFs to introduce functional groups to these cation sites (see Wang et al., Amine-Functionalized Metal Organic Framework as a Highly Selective Adsorbent for CO₂ over CO, J. Phys. Chem. C 116 (2012), 19814-19821). These post-functionalization processes, however, suffer from the need to use multiple steps to implement the functional groups, which can further lead to partial or complete framework collapse.

### SUMMARY OF THE INVENTION

The present invention provides a solution to the inefficiencies discussed above concerning post-functionalization processes for MOFs and the subsequent use of the functionalized MOFs to prepare mixed matrix membranes. The solution is premised on modifying MOFs with a nitrene compound by heating a mixture comprising an azide compound and MOFs to generate a nitrene compound and covalently bonding the nitrene compound to the MOFs. The resulting modified MOFs (e.g., modified ZIFs) include an NH₂ group that can be used to covalently bind the MOFs to one or more polymers in a polymeric membrane. Notably, non-functionalized MOFs (i.e., MOFs that have not undergone a post synthetic functionalization) can be used with this process, thereby reducing the processing steps typically required to first obtain functionalized MOFs when producing mixed matrix membranes. Still further, the pore size of the MOFs can be tuned as desired (e.g., tune gas separation membranes for a particular separation process) based on the properties of the chosen azide compound. Without wishing to be bound by theory, it is believed that the nitrene compound can covalently attach to the MOFs through insertion into a C—H bond (e.g., a methyl group having a C—H bond), thereby allowing non-functionalized MOFs to be used in this process. Notably, however, functionalized MOFs can also be used with the processes of the present invention, thus allowing for a wide-range of selection of MOFs (e.g., non-functionalized or functionalized) and increased tunability of the resulting mixed-matrix membranes. In one embodiment, it has also been discovered that the nitrene modification of the MOFs can be performed in the presence of a polymer, or blend thereof, such that the MOFs can be modified and covalently bound to the polymer, or blend thereof, via the nitrene compound, thereby allowing for in situ production of a mixed-matrix membrane. By way of example, MOFs, an azide, and a polymer material or blend thereof can be mixed together and heated to form a cross-linked mixed matrix membrane in a “one pot” synthesis scheme, thus eliminating the need to perform additional steps to functionalize the MOFs and to couple the MOFs to the polymeric material. Even further, the nitrene compounds can also directly cross link the polymers, thereby allowing for MOF—polymer covalent bonding and polymer—polymer covalent bonding of the resulting mixed-matrix membrane.

In one aspect of the present invention, a method of modifying a metal-organic framework (MOF) is described. The method can include (a) heating a mixture comprising an azide compound and a MOF to generate a nitrene compound and nitrogen (N₂) from the azide compound; and (b) covalently bonding the nitrene compound to the MOF to obtain the modified MOF. The mixture can be heated to 100° C. to 250° C. for 1 to 24 hours. In some embodiments, the MOF can be a zeolitic imidazolate framework (ZIF) and the nitrene compound covalently attaches to the imidazole of the ZIF. The ZIF can be any ZIF described throughout this specification such as a methyl imidazole carboxy aldehyde, a methyl imidazole, or a combination thereof, preferably ZIF-8. In a particular aspect, the imidazole is a methyl imidazole and the nitrene compound covalently attaches to the methyl group of the methyl imidazole. The azide compound can be a mono-azide, a diazide, a tri-azide, or a tetra-azide, or any combination thereof. In some aspects, the azide is diazide such as 4,4′-diazidodiphenyl ether. In other aspects, the azide is a mono azide. A weight ratio of the MOF to the azide compound in the mixture can be from 99.5:1, preferably 50:20. The mixture can also include a solvent that is suitable for solubilizing the MOF and azide compound. The solvent can be removed prior to or during the heating step. The modified MOF can be dried. In one embodiment, the produced modified (MOF) is subsequently mixed with a polymer or polymer blend to produce a mixed matrix polymeric material and subsequent heating allows the nitrene to crosslink the polymeric material. The mixture can also include a polymer or polymer blend. The nitrene compound can attach to the MOF and to the polymer to form a cross-linked mixed matrix polymeric material. The nitrene compound can also crosslink the polymer chain. Without wishing to be bound by theory, it is believed that the crosslinking of the polymers and the attachment of the MOF to the polymer can occur at the same time. The polymer can be a polymer of intrinsic microporosity (PIMs), a polyetherimide (PEI) polymer, a polyetherimide-siloxane (PEI-Si) polymer, or a polyimide (PI) polymer, or blends thereof. In some aspects, the polymer is a polyimide or blend thereof such as 6FDA-Durene or 6FDA-DAM, preferably 6FDA-DAM. The mixture can include, by weight 95% to 50% of the polymer, 1% to 20% by weight of the azide compound and from 4% to 30% by weight of the MOF. A solvent can be added to the mixture to solubilize the polymer, MOF and the azide compound. Removal of the solvent can occur prior to or during heating of the mixture at 100° C. to 250° C. for 1 to 24 hours. In a particular embodiment, the azide compound is 4,4′-oxybis(azido)benzene, the polymer is 6FDA-DAM and the MOF is ZIF-8, and the polymeric material is characterized by FT-IR peaks at 1787 cm⁻¹ and 1731 cm⁻¹.

In some embodiments, a modified MOF or a mixed matrix polymeric material can be produced by any one of the methods described herein.

In another aspect of the invention, a thermally treated cross-linked mixed matrix polymeric material is described. The thermally treated cross-linked mixed matrix polymeric material can include a polyimide containing polymeric matrix and metal-organic frameworks (MOFs), wherein the MOFs are attached to the matrix through a dinitrene cross-linking compound that covalently binds to the polyimides and to the MOFs. The MOF can be a zeolitic imidazolate framework (ZIF) and the dinitrene compound can be covalently attached to the imidazole of the ZIF. The ZIF can be any ZIF described throughout the specification. In a particular embodiment, the imidazole is a methyl imidazole (e.g., ZIF-8) and the nitrene compound covalently attaches to the methyl group of the methyl imidazole. The dinitrene compound can be the reaction product of a diazide that has been heat treated, for example, at a temperature of 100° C. to 250° C. for 1 hour to 24 hours. The diazide can be any diazide described throughout the specification. In one embodiment, the diazide is 4,4′-diazidodiphenyl ether and the polymeric material is characterized by FT-IR peaks at about 1787 cm⁻¹ and 1731 cm⁻¹.

The mixed matrix polymeric material of the present invention can be formed into or is a thin film membrane, a flat sheet membrane, a spiral membrane, a tubular membrane, or a hollow fiber membrane. Such a mixed matrix polymeric material is substantially void-free or a majority of the voids in the membrane are 5 or less Angstroms in diameter.

In another aspect of the invention a method for separating at least one component from a mixture of components is described. The method can include contacting a mixture of components on a first side of the thermally treated cross-linked mixed matrix polymeric material of the present invention, such that at least a first component is retained on the first side in the form of a retentate and at least a second component is permeated through the material to a second side in the form of a permeate. The retentate and/or the permeate can be subjected to a purification step. The first component can be a first gas such as hydrogen and the second component can be a second gas such as propane, nitrogen, or methane. In other aspects the first gas can be carbon dioxide and the second gas can be methane or nitrogen. In another embodiment, the first gas can be an olefin such as propylene and the second gas can be a paraffin such a propane. A pressure at which the mixture is feed to the material is from 1 to 20 atm at a temperature ranging from 20 to 65° C.

Also disclosed is a gas separation device that includes any one of the polymeric membranes of the present invention. The gas separation device can include an inlet configured to accept feed material, a first outlet configured to expel a retentate, and a second outlet configured to expel a permeate. The device can be configured to be pressurized so as to push feed material through the inlet, retentate through the first outlet, and permeate through the second outlet. The device can be configured to house and utilize flat sheet membranes, spiral membranes, tubular membranes, or hollow fiber membranes of the present invention.

In the context of the present invention embodiments 1 to 50 are disclosed. Embodiment 1 is a method of modifying a metal-organic framework (MOF). The method includes (a) heating a mixture comprising an azide compound and a MOF to generate a nitrene compound and nitrogen (N₂) from the azide compound; and (b) covalently bonding the nitrene compound to the MOF to obtain the modified MOF. Embodiment 2 is the method of embodiment 1, wherein the mixture is heated to 100° C. to 250° C. for 1 hour to 24 hours. Embodiment 3 is the method of embodiment 2, wherein the MOF is a zeolitic imidazolate framework (ZIF). Embodiment 4 is the method of embodiment 3, wherein the nitrene compound covalently attaches to the imidazole of the ZIF. Embodiment 5 is the method of embodiment 4, wherein the imidazole of the ZIF is a methyl imidazole carboxyaldehyde, a methyl imidazole, or a combination thereof. Embodiment 6 is the method of embodiment 5, wherein the imidazole is a methyl imidazole and the nitrene compound covalently attaches to the methyl group of the methyl imidazole. Embodiment 7 is the method of embodiment 6, wherein the ZIF is ZIF-8. Embodiment 8 is the method of any one of embodiments 1 to 7, wherein the azide compound is a mono-azide, a diazide, a tri-azide, or a tetra-azide, or any combination thereof. Embodiment 9 is the method of embodiment 8, wherein the azide compound is a diazide. Embodiment 10 is the method of embodiment 9, wherein the diazide is 4,4′-diazidodiphenyl ether. Embodiment 11 is the method of embodiment 10, wherein azide compound is a mono-azide. Embodiment 12 is the method of any one of embodiments 1 to 11, wherein a weight ratio of the MOF to the azide compound in the mixture is from 99.5 to 1, preferably from 50 to 20. Embodiment 13 is the method of any one of embodiments 1 to 12, wherein the mixture further includes a solvent, wherein the MOF and the azide compound are solubilized in the solvent, and wherein the solvent is removed prior to or during the heating step. Embodiment 14 is the method of any one of embodiments 1 to 13, wherein the modified MOF is subsequently dried. Embodiment 15 is the method of any one of embodiments 1 to 14, wherein the produced modified (MOF) is subsequently mixed with a polymer or polymer blend to produce a mixed matrix polymeric material. Embodiment 16 is the method of any one of embodiments 1 to 14, wherein the mixture further includes s a polymer or polymer blend, wherein the nitrene compound attaches to the MOF and to the polymer to form a cross-linked mixed matrix polymeric material. Embodiment 17 is the method of any one of embodiments 16, wherein the polymer is a polymer of intrinsic microporosity (PIMs), a polyetherimide (PEI) polymer, a polyetherimide-siloxane (PEI-Si) polymer, or a polyimide (PI) polymer, or blends thereof. Embodiment 18 is the method of embodiment 17, wherein the polymer is a polyimide or blend thereof. Embodiment 19 is the method of embodiment 18, wherein the polyimide is 6FDA-Durene or 6FDA-DAM, preferably 6FDA-DAM. Embodiment 20 is the method of any one of embodiments 15 to 19, wherein the mixture includes, by weight, from 95% to 50% of the polymer, from 1% to 20% of the azide compound, and from 4% to 30% of the MOF. Embodiment 21 is the method of embodiment 20, wherein the mixture further includes a solvent, and wherein the polymer, the MOF, and the azide compound are solubilized in the solvent. Embodiment 22 is the method of embodiment 21, wherein the solvent is substantially removed from the mixture prior to or during heating of the mixture, and wherein the mixture is heated to 100° C. to 250° C. for 1 hour to 24 hours. Embodiment 23 is the method of embodiment 22, wherein the azide compound is 4,4′-oxybis(azido)benzene, the polymer is 6FDA-DAM and the MOF is ZIF-8. Embodiment 24 is the method of embodiment 23, wherein the polymeric material is characterized by FT-IR peaks at 1787 cm⁻¹ and 1731 cm⁻¹. Embodiment 25 is the method of any one of embodiments 15 to 24, further including forming the mixed matrix polymeric material into a thin film membrane, a flat sheet membrane, a spiral membrane, a tubular membrane, or a hollow fiber membrane. Embodiment 26 is the method of embodiment 25, wherein the mixed matrix polymeric material is substantially void-free or a majority of the voids in the membrane are 5 or less Angstroms in diameter. Embodiment 27 is a modified metal-organic framework (MOF) produced by any one of the methods of embodiments 1 to 14. Embodiment 28 is a mixed matrix polymeric material produced by any one of the methods of embodiments 15 to 26.

Embodiment 29 is a thermally treated cross-linked mixed matrix polymeric material comprising a polyimide containing polymeric matrix and metal-organic frameworks (MOFs), wherein the MOFs are attached to the matrix through a dinitrene cross-linking compound that covalently binds to the polyimides and to the MOFs. Embodiment 30 is the thermally treated mixed matrix polymeric material of embodiment 29, wherein the MOF is a zeolitic imidazolate framework (ZIF) and the dinitrene compound is covalently attached to the imidazole of the ZIF. Embodiment 31 is the thermally treated cross-linked mixed matrix polymeric material of embodiment 30, wherein the imidazole of the ZIF is a methyl imidazole carboxyaldehyde, a methyl imidazole, or a combination thereof. Embodiment 32 is the thermally treated cross-linked mixed matrix polymeric material of embodiment 31, wherein the imidazole is a methyl imidazole and the nitrene compound covalently attaches to the methyl group of the methyl imidazole. Embodiment 33 is the thermally treated cross-linked mixed matrix polymeric material of embodiment 32, wherein the ZIF is ZIF-8. Embodiment 34 is the thermally treated cross-linked mixed matrix polymeric material of any one of embodiments 29 to 33, wherein the dinitrene compound is the reaction product of a diazide compound that has been heat-treated. Embodiment 35 is the thermally treated cross-linked mixed matrix polymeric material of embodiment 34, wherein the diazide is 4,4′-diazidodiphenyl ether. Embodiment 36 is the thermally treated cross-linked mixed matrix polymeric material of embodiment 35, wherein the polymeric material is characterized by FT-IR peaks at about 1787 cm⁻¹ and 1731 cm⁻¹. Embodiment 37 is the thermally treated cross-linked mixed matrix polymeric material of any one of embodiments 29 to 36, wherein the polymeric material has been heat-treated for 1 hours to 24 hours at a temperature of 100° C. to 250° C. Embodiment 38 is the thermally treated cross-linked mixed matrix polymeric material of any one of embodiments 29 to 37, wherein the material is a thin film membrane, a flat sheet membrane, a spiral membrane, a tubular membrane, or a hollow fiber membrane. Embodiment 39 is the thermally treated cross-linked mixed matrix polymeric material of any one of embodiments 29 to 38, wherein the mixed matrix polymeric material is substantially void-free or a majority of the voids in the membrane are 5 or less Angstroms in diameter.

Embodiment 40 is a method for separating at least one component from a mixture of components, the method comprising contacting a mixture of components on a first side of the thermally treated cross-linked mixed matrix polymeric material of any one of embodiments 29 to 39, such that at least a first component is retained on the first side in the form of a retentate and at least a second component is permeated through the material to a second side in the form of a permeate. Embodiment 41 is the method of embodiment 40, wherein the first component is a first gas and the second component is a second gas. Embodiment 42 is the method of embodiment 41, wherein the first gas is hydrogen and the second gas is propane, nitrogen, or methane, or wherein the first gas is carbon dioxide and the second gas is methane or nitrogen. Embodiment 43 is the method of embodiment 41, wherein the first gas is an olefin and the second gas is a paraffin. Embodiment 44 is the method of embodiment 43, wherein the olefin is propylene and the second gas is propane. Embodiment 45 is the method of any one of embodiments 40 to 44, wherein the pressure at which the mixture is feed to the material is from 1 to 20 atm at a temperature ranging from 20 to 65° C. Embodiment 46 is the method of any one of embodiments 40 to 45, wherein the retentate and/or the permeate is subjected to a purification step. Embodiment 47 is a gas separation device comprising the thermally treated cross-linked mixed matrix polymeric material of any one of embodiments 28 to 46. Embodiment 48 is the gas separation device of embodiment 47, further comprising an inlet configured to accept feed material, a first outlet configured to expel a retentate, and a second outlet configured to expel a permeate. Embodiment 49 is the gas separation device of embodiment 48, configured to be pressurized so as to push feed material through the inlet, retentate through the first outlet, and permeate through the second outlet. Embodiment 50 is the gas separation device of embodiment 49, configured for using a thin film membrane, a flat sheet membrane, a spiral membrane, a tubular membrane, or a hollow fiber membrane.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The term “substantially” and its variations are defined as being largely but not necessarily wholly what is specified as understood by one of ordinary skill in the art, and in one non-limiting embodiment substantially refers to ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods or membranes of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the methods of the present invention is the ability to produce post functionalized MOFs and cross-linked membranes.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A-1C are schematics of the synthesis of (A) ZIF-8, (B) ZIF-8-90, and (C) ZIF-8-90-EDA.

FIG. 2 are non-limiting examples of azide compounds that can be used in the context of the present invention.

FIG. 3 depicts a reaction scheme of an embodiment of a mono-azide reacting with a ZIF.

FIG. 4 depicts a reaction scheme of an embodiment of a diazide reacting with a ZIF.

FIG. 5 depicts a reaction scheme of an embodiment of a mono-azide with a modified MOF and a polymeric material.

FIG. 6 depicts a reaction scheme of an embodiment of a diazide with a ZIF and a polyimide.

FIG. 7 is a scanning electron microscope (SEM) image of the ZIF-8 particles.

FIG. 8 shows XRD patterns of the simulated ZIF-8, synthesized ZIF-8, and the ZIF-8 functionalized with a diazide.

FIG. 9 are Fourier-Transform infrared (FT-IR) spectra of ZIF-8 at room temperature and spectra of mixtures of ZIF-8 and 1,1′-oxybis(4-azidobenzene) at various reaction times and temperatures.

FIG. 10 shows pore size distribution curves of ZIF-8 and ZIF-8 modified with 1,1′-oxybis(4-azidobenzene).

FIG. 11 are Fourier-Transform infrared (FT-IR) spectra of polyimide 6FDA-DAM and spectra of mixtures of ZIF-8 and 1,1′-oxybis(4-azidobenzene) and polyimide 6FDA-DAM at various reaction times and temperatures.

FIG. 12 depicts the XRD patterns of ZIF-8, mixed matrix polymeric material (ZIF-8 and 1,1′-oxybis(4-azidobenzene) and polyimide 6FDA-DAM prior to heating at 180° C. and cross linked mixed matrix polymeric material of the present invention.

### DETAILED DESCRIPTION OF THE INVENTION

The currently available methods used to make post-functionalized MOFs and mixed matrix membranes involve multiple step chemical reactions. These reactions can cause partial or complete framework collapse and/or are time intensive.

The present invention provides a solution to these problems through an elegant method of modifying MOFs, and if so desired, making mixed matrix polymeric membranes from the modified MOFs. In certain aspects, the modification of the MOFs and preparation of the mixed matrix polymeric membranes can be performed in situ or in a one-pot synthesis scheme. By way of example, azide compounds can be mixed and heated with MOFs and a polymer material or blend thereof. Upon heating the mixture, the azide can decompose to a nitrene intermediate. The nitrene intermediate can promote cross-linking of the polymeric material and form a nitrogen linker that covalently bonds the polymeric material to the MOFs.

These and other non-limiting aspects of the present invention are discussed in further detail in the following sections.

### A. Modification of Metal-Organic Framework Compounds (MOFs)

1. Metal-Organic Framework Compounds (MOFs)

MOFs compounds can have metal ions or clusters coordinated to organic molecules to form one-, two-, or three-dimensional structures that can be porous. By themselves, MOFs have been demonstrated to have very high gas sorption capacities, which suggest that gases generally will diffuse readily through MOFs if incorporated into a membrane. The properties of MOFs can be tuned for specific applications using methods such as chemical or structural modifications.

MOFs that can be functionalized in the manner described herein can be used in to prepare membranes and/or other materials. Non-limiting examples of MOFs include, but are not limited to, IRMOF-3, MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH₂, UMCM-1-NH₂, MIL-53-NH₂ and MOF-69-80.

In some embodiments, the MOFs are zeolitic imidazolate frameworks (ZIFs). ZIFs are a subclass or species of MOFs which have ordered porous structures with hybrid frameworks consisting of MN₄ (M=Co, Cu, Zn, etc.) clusters coordinated with organic imidazolate ligands. Similar to other ordered porous materials like zeolites, the regular ZIF structure can be utilized in membrane related applications such as separations, membrane reactors, and chemical sensors. ZIFs have attractive properties such as high specific surface area, high stability, and chemically flexible framework that can be modified with functional groups by post-synthesis methods. Pure ZIF membranes have high performance at gas separation, but their applications are limited by high preparation cost. ZIFs can be made using known synthetic methods. A non-limiting example includes synthesizing ZIFs using solvothermal methods. Highly crystalline materials can be obtained by combining the requisite hydrated metal salt (e.g., nitrate) and imidazole-type linker in an amide solvent such as N,N-diethylformamide (DEF). The resulting solutions can be heated (85-150° C.) and zeolitic frameworks of the disclosure can be precipitated after 48-96 h and readily isolated. In another example, highly crystalline materials can be obtained by combining the requisite hydrated metal salt (e.g., nitrate) and imidazole-type linker in an alcohol solvent such as methanol with agitation. After a period of time (for example, 3 hours), the mixture becomes turbid and the crystalline material can be separated using known filtration techniques. In a further aspect, the imidazolate structures or derivatives can be further functionalized as described throughout the specification to impart functional groups that line the cages and channel, and particularly the pores to obtain a desired structure or pore size.

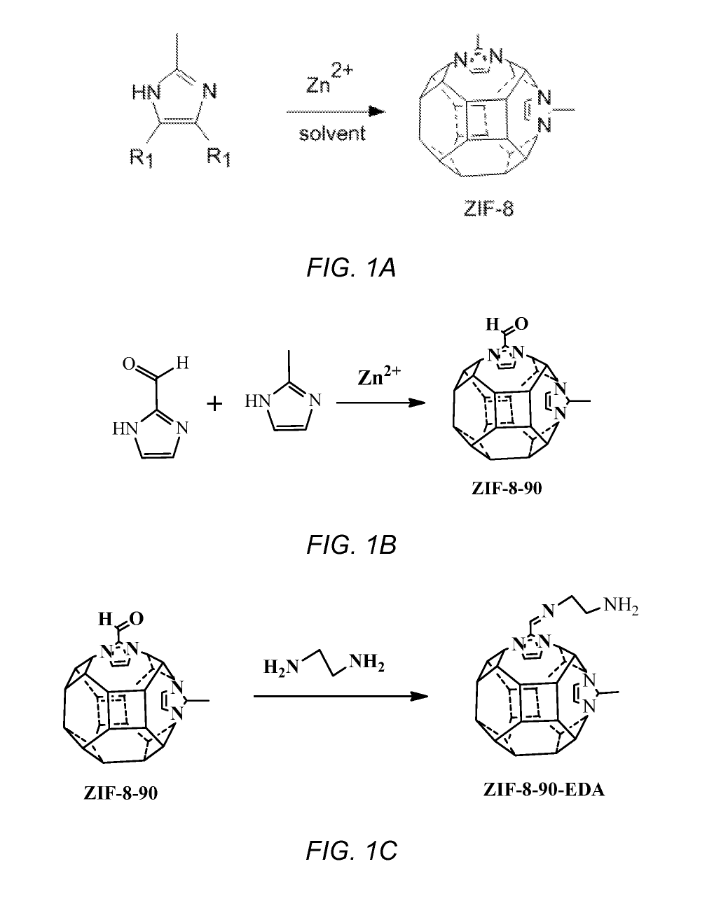

In some aspects, the zeolitic imidazolate frameworks are synthesized from zinc salts and an imidazole ligand or a mixture of imidazole ligands. Non-limiting examples of such frameworks that can be used in the context of the present invention include ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-60, ZIF-62, ZIF-64, ZIF-65, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-86, ZIF-90, ZIF-91, ZIF-92, ZIF-93, ZIF-95, ZIF-96, ZIF-97, ZIF-100 and hybrid ZIFs, such as ZIF-7-8, ZIF-8-90. In some preferred embodiments, ZIF-8, ZIF-8-90, or ZIF-8-90-EDA can be used, with ZIF-8 being most preferred. FIGS. 1A-1C provide schematics of the synthesis of ZIF-8, ZIF-8-90, and ZIF-8-90-EDA, respectively, each of which have the following structures:

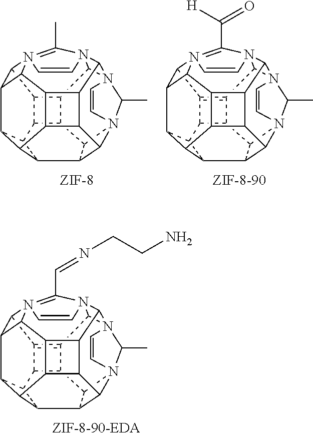

Non-limiting examples, of imidazole compounds that can be used to synthesize ZIFs are shown below. One or more imidazole compound can be used to make ZIFs, for example, a mixture of two imidazole compounds can be used to make a ZIF. In a preferred instance, 2-methylimidazole is used to make the ZIF.

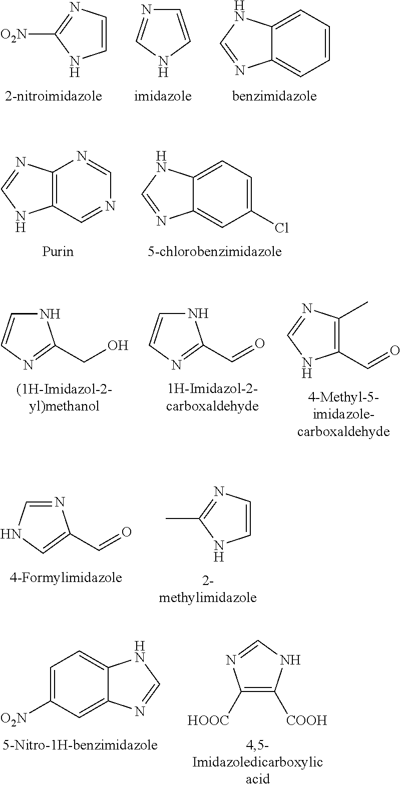

2. Azide Compounds

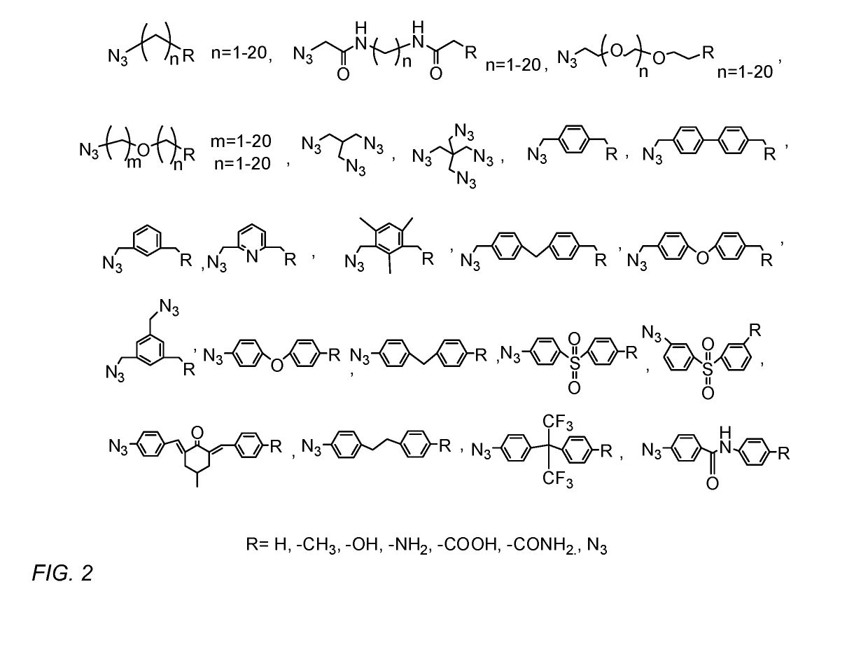

The MOFs can be reacted with an azide compound to produce a modified MOF that includes one or more nitrogen atoms (e.g., a linker group). The nitrogen linker can be used to covalently bond the MOF to polymeric material as described throughout this specification. The azide compounds can be made as described herein. A non-limiting example of making an azide is to react 4,4′-dioxyaniline with sodium nitrite under acidic conditions to form the resulting azide. Azide compounds that can be used include mono-azide compounds, diazide compounds, tri-azide compounds, and tetra-azide compounds. Non-limiting examples of azides are shown in FIG. 2. The mono-azides can be represented by the general chemical formula of:

N₃—R¹, and

diazides can be represented by the general chemical formula of:

N₃—R¹—N₃

where R¹ in the azide and diazide can be varied to create a wide range of mono- or di-azides that produce useable nitrene intermediates. Due to the high reactivity of some azides, the azides may be synthesized, isolated and used immediately. For example, methyl azide may be synthesized in situ and immediately reacted with the MOF. Non-limiting examples of R¹ include an a straight chain alkyl group, a branched alkyl group, a cycloalkyl group, an alkenyl group, an alkynyl group, an alkoxy group, an aryloxy group, heterocyclic group, a monocyclic aromatic group, a substituted aromatic group, an aryl group, an alkylaryl group, an arylalkyl group, an alkene group, an amido group, an aryl group, arylsulfonyl group, an alkylsulfonyl group, and combinations thereof. The groups can include one or more halogens. The groups can include one or more halogens. In one instance, R¹ can be a straight-chain or branched hydrocarbon groups having up to about 20 carbon atoms (C₁-C₂₀-alkyl group), for example C₁-C₁₀-alkyl or C₁₁-C₂₀-alkyl, or a C₁-C₁₀-alkyl, for example C₁-C₃-alkyl, such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, or C₇-C₁₀-alkyl such as heptyl, octyl, 2-ethylhexyl, 2,4,4-trimethylpentyl, 1,1,3,3-tetramethylbutyl, nonyl or decyl, and/or isomers or combinations thereof. In some instances, the mono-azide can be methyl azide, ethyl azide, propyl azide, 1-azidobutane, 1-azidopentane, 1-azidohexane, 1-azidoheptane, 1-azidooctane, 1-azidononane, 1-azidodecane, 1-azidoundecane, 1-azidotridecan, 1-azdiotetradecane, 1-azidopentadecane, 1-azidohexadecane, 1-azidoheptadecane, 1-azidononadecane, 1-azidoeicosane, 4-(azidomethyl)-1-methylbenzene and derivatives thereof, 2-azidomethyl-1-ethylbenzene; 4-(azidomethyl)-1-alkoxybenzene; 4-(azidomethyl)benzylamine; 4-(azidomethyl)phenyl ethanoic acid; 4-(azidomethyl)benzamide; 2-(azidomethyl)-1,3,4,5-tetramethylbenzene; 3-(azidomethyl)-2,4,5-trimethyl-1-ethylbenzene; 3-(azidomethyl)-2,4,5-trimethyl-1-alkoxybenzene; 3-(azidomethyl)-2,4,5-trimethyl-benzylamine; 3-(azidomethyl)-2,4,5-trimethyl-benzamide; 3-(azidomethyl)-2,4,5-trimethyl-1-ethanoic acid; 4-(azidomethyl)-4-benzamide. In a particular instance, the diazide is 1,1′-oxybis(4-azidobenzene) (CAS No. 48180-65-0), shown below.

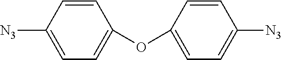 [SMILES: [N-]=[N+]=Nc1ccc(Oc2ccc(N=[N+]=[N-])cc2)cc1]

Tri-azides can be represented by the general chemical formula of N₃—CH₂CH(CH₂N₃)₂. Tetra-azides can be represented by the general chemical formula of N₃—CH₂C(CH₂N₃)₃. Synthetic routes to make azides are described by Bräze et al. in Angew. Chem Int. Ed., 2005, 44, 5188-5240, and Thomas et al. in J. Am. Chem. Soc., 2005, 127, 12534-12435, both of which are incorporated herein by reference. Azides are also commercially available from chemical suppliers such as Sigma-Aldrich® (USA), Apollo Scientific Ltd (United Kingdom), ShangHai Boc Chem Co., Ltd. (China), eNovation Chemicals, LLC (U.S.A.) and Ryan Scientific (U.S.A.).

3. Nitrene Modification and Tuning of MOFs

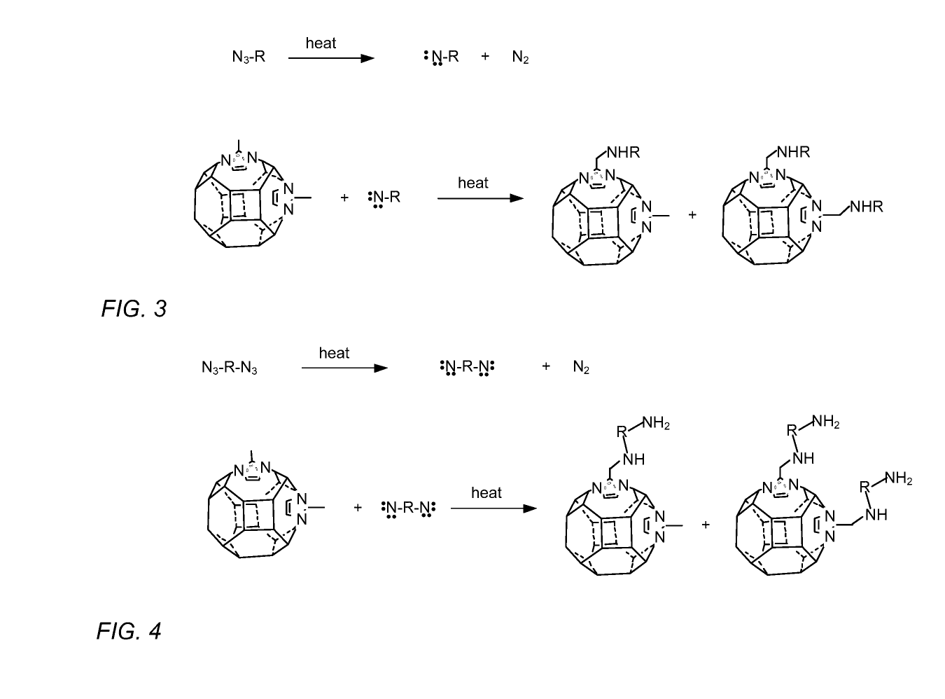

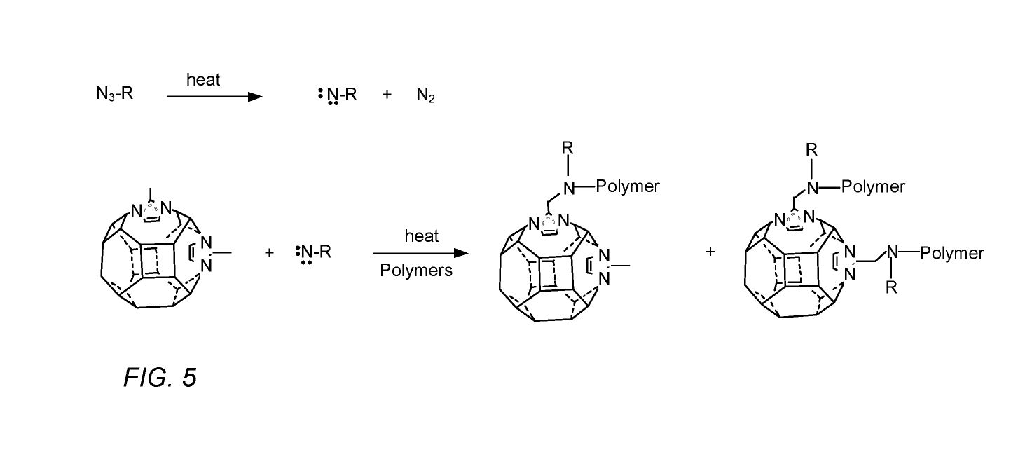

As illustrated in the Examples section, the modified MOFs can be prepared by heating a mixture of MOFs (e.g., ZIFs) and the azide compound in an appropriate solvent (e.g., methylene chloride, dimethyl sulfoxide, acetonitrile, etc.). The choice of solvent should be compatible with the reactive nature of the azide. For example, chlorinated solvents would not be used with azides having a carbon number less than nine. A weight ratio of the MOF to the azide compound in the mixture can range from 99.5 to 1, 80:10, 50:20 or any ratio there between. The mixture can be heated at a temperature from 100° C. to 250° C., 110° C. to 225° C., 150° C. to 200° C., or about 175° C. or any temperature there between under reduced pressure of about 0.01-10 Torr, or 0.01, 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10, or any value or range there between for about 1, 2, 3, 4, 5, 6, 7, 8, 9, 10, 11, 12, 13, 14, 15, 16, 17, 18, 19, 20, 21, 22, 23, 24 hours or any range there between. The temperature can then be increased to about from a lower temperature to a higher temperature (for example, 100° C. to 250° C.) while remaining under reduced pressure of about 0.01 to 10 Torr. The resulting modified MOF includes an amine functional group that can be used as a linker in reactions with other compounds (for example, polymeric material, or organic compounds). Heating of the azide generates a nitrene intermediate and nitrogen (N₂) gas. The reactive nitrene intermediate can attach to a carbon or a functional group on the MOF. FIGS. 3 and 4 depict reaction schemes of a mono-azide and a diazide reacting with a ZIF.

The addition of the nitrene group to create modified ZIFs provides an avenue to tune the pore size of the modified ZIF. In particular, the pore size of the modified ZIFs can be controlled by the ratio of the imidazole ligands to the introduced nitrene groups, and the pore sizes may be adjusted by changing the ligands on MOFs (e.g., changing the imidazole compounds on the MOFs) and/or changing the size of the R groups in the azide. These pore sizes can be used to increase or tune the selectivity of the membrane for particular gases and other compounds in order to target the desired molecule or compound. Not wishing to be bound by theory, it is believed that the azide compounds react with the ligands of the ZIF, which will reduce the pore size of the ZIF. In some instances the pore size is reduce due to steric hindrance. In addition, the selection of the polymer for the membrane can also determine the selectivity of the membrane.

### B. Mixed Matrix Polymeric Material

1. Polymeric Material

Non-limiting examples of polymers that can be used in the context of the present invention include polyimide (PI) polymers. Additional polymers that can be used are polymers of intrinsic microporosity (PIMs), polyetherimide (PEI) polymers, and polyetherimide-siloxane (PEI-Si) polymers. As noted above, the membranes can include a blend of any one of these polymers (including blends of a single class of polymers and blends of different classes of polymers).

a). Polyimide Polymers

Polyimide (PI) polymers are polymers of imide monomers. The general monomeric structure of an imide is:

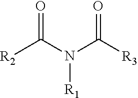

Polymers of imides generally take one of two forms: heterocyclic and linear forms. The structures of each are:

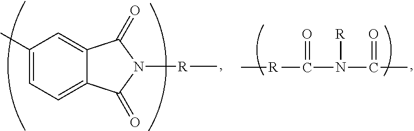

where R can be varied to create a wide range of usable PI polymers. A non-limiting example of a specific PI (i.e., 6FDA-Durene) that can be used is described in the following reaction scheme:

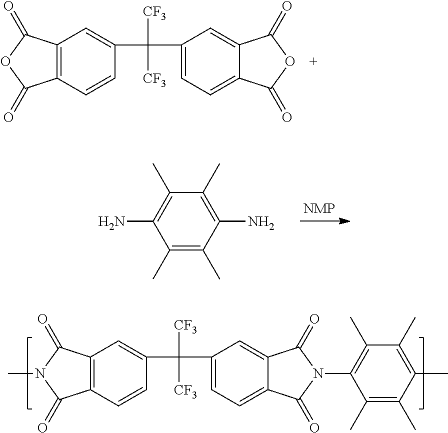

Additional PI polymers that can be used in the context of the present invention are described in U.S. Pat. No. 8,613,362, which is incorporated by reference. For instance, such PI polymers include both UV crosslinkable functional groups and pendent hydroxy functional groups: poly[3,3′,4,4′-benzophenonetetracarboxylic dianhydride-2,2-bis(3-amino-4-hydroxyphenyl)-hexafluoropropane] (poly(BTDA-APAF)), poly[4,4′-oxydiphthalic anhydride-2,2-bis(3-amino-4-hydroxyphenyl)-hexafluoropropane] (poly(ODPA-APAF)), poly(3,3′,4,4′-benzophenonetetracarboxylic dianhydride-3,3′-dihydroxy-4,4′-diamino-biphenyl) (poly(BTDA-HAB)), poly[3,3′,4,4′-diphenylsulfone tetracarboxylic dianhydride-2,2-bis(3-amino-4-hydroxyphenyl)-hexafluoropropane] (poly(DSDA-APAF)), poly(3,3′,4,4′-diphenyl sulfone tetracarboxylic dianhydride-2,2-bis(3-amino-4-hydroxyphenyl)-hexafluoropropane-3,3′-dihydroxy-4,4′-diamino-biphenyl) (poly(DSDA-APAF-HAB)), poly[2,2′-bis-(3,4-dicarboxyphenyl) hexafluoropropane dianhydride-3,3′,4,4′-benzophenonetetracarboxylic dianhydride-2,2-bis(3-amino-4-hydroxyphenyl)-hexafluoropropane] (poly(6FDA-BTDA-APAF)), poly[4,4′-oxydiphthalic anhydride-2,2-bis(3-amino-4-hydroxyphenyl)-hexafluoropropane-3,3′-dihydroxy-4,4′-diamino-biphenyl] (poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihydroxy-4,4′-diamino-biphenyl] (poly(BTDA-APAF-HAB)), and poly(4,4′-bisphenol A dianhydride-3,3′,4,4′-benzophenonetetracarboxylic dianhydride-2,2-bis(3-amino-4-hydroxyphenyl)-hexafluoropropane] (poly(BPADA-BTDA-APAF)). Polyimide powders are commercially available trade names of Matrimid® (Huntsman, USA), P84® (Evonik, Germany), Extem™ (Sabic Innovative Plastics, USA), Kapton® (DuPont, USA).

b). Polymers of Intrinsic Microporosity (PIM)

PIMs are typically characterized as having repeat units of dibenzodioxane-based ladder-type structures combined with sites of contortion, which may be those having spiro-centers or severe steric hindrance. The structures of PIMs prevent dense chain packing, causing considerably large accessible surface areas and high gas permeability. The molecular weight of said polymers can be varied as desired by increasing or decreasing the length of said polymers. PIM polymers are described in U.S. Pat. Nos. 7,758,751 and 8,623,928, and by Ghanem et. al., in High-Performance Membranes from Polyimides with Intrinsic Microporosity, Adv. Mater. 2008, 20, 2766-2771, all of which are incorporated herein by reference. A non-limiting example of a PIM is shown below:

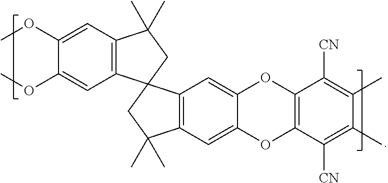

c). Polyetherimide and Polyetherimide-Siloxane Polymers

Polyetherimide polymers that can be used in the context of the present invention are described in U.S. Pat. No. 8,034,857, which is incorporated into the present application by reference. Non-limiting examples of specific PEIs that can be used include those sold under the trade names Ultem® and Extern®, (Sabic Innovative Plastics, USA). All various grades of Extern® and Ultem® are contemplated as being useful in the context of the present invention (e.g., Extern® (VH1003), Extern® (XH1005), and Extern® (XH1015)).

Polyetherimide siloxane (PEI-Si) polymers can be also used in the context of the present invention. Examples of polyetherimide siloxane polymers are described in U.S. Pat. No. 5,095,060, which is incorporated by reference. A non-limiting example of a specific commercially available PEI-Si polymer that can be used includes the polymer sold under the trade name Siltem® (SABIC Innovative Plastics USA). All various grades of Siltem® are contemplated as being useful in the context of the present invention (e.g., Siltem® (1700) and Siltem® (1500)).

### C. Preparing the Mixed Matrix Polymeric Material

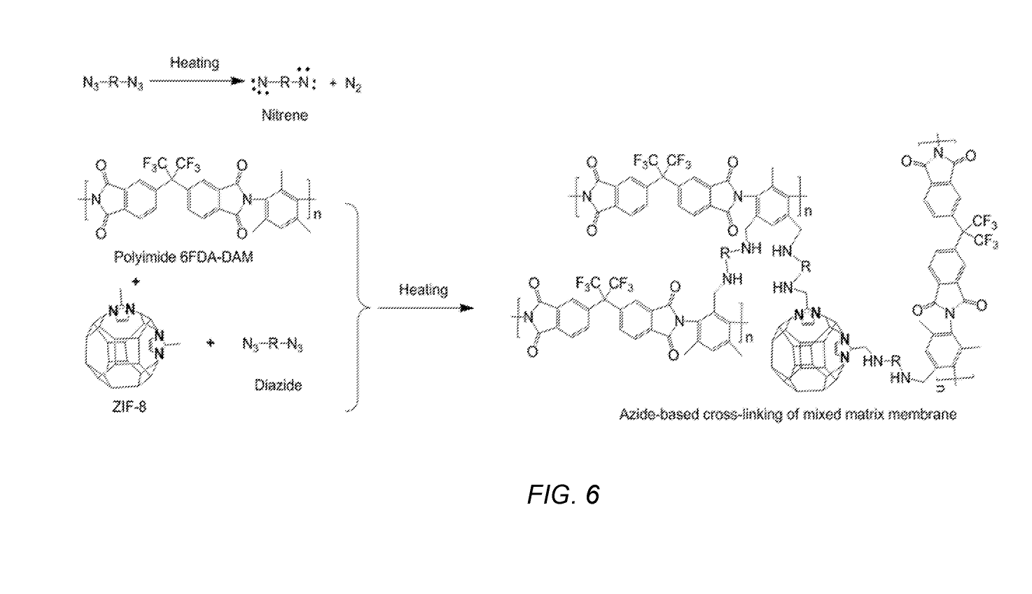

The MOFs (e.g., modified ZIFs) described throughout the specification and the Examples can be used to produce mixed matrix membranes. The MOFs can have a single attachment or multiple attachments sites. Specifically, the MOFs can be attached to the polymeric material described throughout the specification through a nitrene intermediate, which reacts with the MOF and the polymeric material to produce mixed matrix polymeric membranes. In some instances, the MOF can be reacted with a nitrene intermediate, the nitrene modified MOF isolated (See, FIGS. 3 and 4), and then reacted with polymeric material to form the mixed matrix material. In some instances the attachment is done is one pot without isolation of the nitrene modified MOF. Without wishing to be bound by theory, it is believed that the attachment of the MOF to the polymeric material can be through a nitrogen linker (derived from the nitrene intermediate) that covalently bonds to the MOF and to the polymeric material. The bonding can be step-wise or occur simultaneously depending on the reaction conditions. FIGS. 5 and 6 illustrate attachment of polymers to ZIFs using nitrene compounds or dinitrene compounds. FIG. 5 depicts a reaction scheme of an embodiment of a monoazide with a ZIF and a polymeric material. In FIG. 5, two products are shown 1) a single polymer attached to the ZIF through a single nitrogen linker atom that originated from the nitrene intermediates generated in situ and 2) two polymer compounds attached to the ZIF through two nitrogen linker atoms that originated from two nitrene intermediates generated in situ. Without wishing to be bound by theory, it is believed that the azide decomposes to form the nitrene compounds, which then reacts with the ZIF and polymeric material to form the mixed matrix membrane. FIG. 6 depicts a reaction scheme of an embodiment of a diazide with a ZIF-8 and a polyimide. As shown in FIG. 6, the polymeric material has been crosslinked with another polymeric material via the diamine linking group (—NH—R—NH—), and the polymeric material is covalently bound to the methyl group of the imidazole through the diamine linking group. Without wishing to be bound by theory, it is believed that the diamine linking group is generated through decomposition of the diazide to from the dinitrene intermediate and nitrogen, which reacts with the polymeric material and the ZIF-8. The R group in the azide of FIGS. 5 and 6 can be varied depending on the type of cross-linking and/or pore modification is desired for the mixed matrix membrane. The choice of polymeric material, MOF, and azide can be chosen (e.g., tunable) for different applications.

In a non-limiting example, the modification and attachment can be obtained by preparing a solution of the ZIF (e.g., ZIF-8), the azide compound (e.g., 1,1′-oxybis(4-azidobenzene)) and the polymeric material (e.g., polyimide) under agitating conditions in an appropriate solvent (e.g., methylene chloride, dimethyl sulfoxide, acetonitrile, etc.). The choice of solvent should be compatible with the reactive nature of the azide. For example, chlorinated solvents would not be used with azides having a carbon number less than nine. The mixture can include, by weight, from 50% to 95%, of the polymer, from 1% to 20% of the azide compound, and from 4% to 30% of the MOF. In some embodiments, the mixture includes by weight 60% to 85%, 65% to 75%, or 50%, 51%, 52%, 53%, 54%, 55%, 56%, 57%, 58%, 59%, 60%, 61%, 62%, 63%, 64%, 65%, 66%, 68%, 69%, 70%, 71%, 72%, 73%, 74%, 75%, 76%, 77%, 78%, 79%, 80%, 81%, 82%, 83%, 84%, 85%, 86%, 87%, 88%, 89% 90%, 91%, 92%, 93%, 94% or 95%, or any range or value there between of the polymer. The mixture can include by weight, from 1% to 20%, 3% to 15%, 5% to 10%, or 1%, 2%, 3%, 4%, 5%, 6%, 7%, 8%, 9%, 10%, 11%, 12%, 13%, 14%, 15%, 16%, 17%, 18%, 19%, 20%, or any range or value there between of the azide compound. The mixture can include, by weight, from 4% to 30%, 5% to 25%, or 10% to 15% or 5%, 6%, 7%, 8%, 9%, 10%, 11%, 12%, 13%, 14%, 15%, 16%, 17%, 18%, 19%, 20%, 21%, 22%, 23%, 24%, 25% or any range or value there between. The mixture can be degassed and then treated through solvent molding or a casting to remove of the solvent to form a polymeric material having the desired properties. Non-limiting examples of casting processes include air casting (i.e., the dissolved polymer solution passes under a series of air flow ducts that control the evaporation of the solvents in a particular set period of time such as 24 to 48 hours), solvent or emulsion casting solvent or emersion casting, (i.e., the dissolved polymer is spread onto a moving belt and run through a bath or liquid in which the liquid within the bath exchanges with the solvent, thereby causing the formation of pores and the thus produced membrane is further dried), or thermal casting (i.e., heat is used to drive the solubility of the polymer in a given solvent system and the heated solution is then cast onto a moving belt and subjected to cooling). The resulting mixed matrix polymeric material can be dried at about 90° C. to 105° C., or 95° C. to 100° C. under reduced pressure of 0.01 to 10 Torr for a period of time (e.g. 1 h, 2 h, 3 h, 4 h, or 24 h). Generation of the nitrene can take place in a thermal treatment furnace at a selected temperature and pressure for a selected period of time to achieve the desired amount of cross-linking and attachment to the MOF. The crosslinking is controlled by the content of azide, temperature and time. In a non-limiting example, the mixed matrix polymeric material can be heated at 160° C. to 200° C., 170° C. to 190° C., or 160° C. to 180° C., or 180° C. for a period of time (e.g., 5 h, 10 h, 12 h, 24 h, or 36 h) to cross-link the polymer matrix and attach the polymer to the MOF. Alternatively, the dried mixed matrix polymeric material can be subjected to UV radiation to generate the nitrene compounds, and subsequent formation of the cross-linked mixed matrix polymeric membrane.

1. Testing and Properties of the Mixed Matrix Polymeric Membranes Treatment

For permeation, testing is based on single gas measurement, in which the system is evacuated. The membrane is then purged with the desired gas three times. The membrane is tested following the purge for up to 8 hours. To test the second gas, the system is evacuated again and purged three times with this second gas. This process is repeated for any additional gasses. The permeation testing is set at a fixed temperature (20-50° C., preferably 25° C.) and pressure (preferably 2 atm).

The mixed matrix membranes of the present invention can be entirely void-free or have substantially fee voids. The generation of the nitrene and in situ cross-linking of the polymeric material and the attachment to the functionalized MOFs can eliminate non-selective interfacial voids that are larger than the penetrating gas molecules between the polymers of the membrane and the MOF entirely (void-free) or can reduce the size of the majority of or all of the voids present between the polymer/MOF interface to less than 5 Angstroms (substantially void-free). The reduction or elimination of these voids effectively improves the selectivity of the membrane.

2. Surface Treatment

The mixed matrix membranes of the present invention can be treated with any combination of these treatments (e.g., plasma and electromagnetic radiation, plasma and thermal energy, electromagnetic radiation and thermal energy, or each of plasma, electromagnetic radiation, and thermal energy). The combination treatments can be sequential or can overlap with one another.

Plasma treatment can include subjecting at least a portion of the surface of the polymeric membrane to a plasma that includes a reactive species. The plasma can be generated by subjecting a reactive gas to a RF discharge with a RF power of 10 W to 700 W. The length of time the surface is subjected to the reactive species can be 30 seconds to 30 minutes at a temperature of 15° C. to 80° C. and at a pressure of 0.1 Torr to 0.5 Torr. A wide range of reactive gases can be used, for example, O₂, N₂, NH₃, CF₄, CCl₄, C₂F₄, C₂F₆, C₃F₆, C₄F₈, Cl₂, H₂, He, Ar, CO, CO₂, CH₄, C₂H₆, C₃H₈, or any mixture thereof. In a particular aspect, the reactive gas can be a mixture of O₂ and CF₄ at a ratio of up to 1:2, where O₂ is provided at a flow rate of 0 to 40 cm³/min. and CF₄ is provided at a flow rate of 30 to 100 cm³/min.

Electromagnetic treatment can include subjecting the membrane to a selected radiation (e.g., UV radiation, microwaves, laser sources, etc.) for a specified amount of time at a constant distance from the radiation source. For example, the membrane can be treated with said radiation for 30 to 500 minutes or from 60 to 300 minutes or from 90 to 240 minutes or from 120 to 240 minutes. Additional thermal treatment, such treatment can take place in a thermal treatment furnace at a selected temperature for a selected period of time. For example, the membrane can be thermally-treated at a temperature of 100 to 400° C. or from 200 to 350° C. or from 250 to 350° C. for 12 to 96 hours or 24 to 96 hours or 36 to 96 hours.

The materials and methods of making the disclosed membranes allows for precise placement of a specified number of MOFs in the membrane. Additionally, specific molecular interactions or direct covalent linking may be used to facilitate ordering or orientation of the MOFs on the polymer or the membrane. Such methods also can eliminate or reduce defects at the molecular sieve/polymer interface.

### D. Membrane Applications

The membranes of the present invention have a wide-range of commercial applications. For instance, and with respect to the petro-chemical and chemical industries, there are numerous petro-chemical/chemical processes that supply pure or enriched gases such as He, N₂, and O₂, which use membranes to purify or enrich such gases. Further, removal, recapture, and reuse of gases such as CO₂ and H₂S from chemical process waste and from natural gas streams is of critical importance for complying with government regulations concerning the production of such gases as well as for environmental factors. In addition, efficient separation of olefin and paraffin gases is key in the petrochemical industry. Such olefin/paraffin mixtures can originate from steam cracking units (e.g., ethylene production), catalytic cracking units (e.g., motor gasoline production), or dehydration of paraffins. Membranes of the invention can be used in each of these as well as other applications. For instance, and as illustrated in the Examples, the treated membranes are particularly useful for H₂/N₂, H₂/CH₄, or CO₂/CH₄ gas separation applications.

The membranes of the present invention can be used in the purification, separation or adsorption of a particular species in the liquid or gas phase. In addition to separation of pairs of gases, the membranes can also be used to separate proteins or other thermally unstable compounds. The membranes may also be used in fermenters and bioreactors to transport gases into the reaction vessel and to transfer cell culture medium out of the vessel. Additionally, the membranes can be used to remove microorganisms from air or water streams, water purification, in ethanol production in a continuous fermentation/membrane pervaporation system, and/or in detection or removal of trace compounds or metal salts in air or water streams.

In another instance, the membranes can be used in the separation of liquid mixtures by pervaporation, such as in the removal of organic compounds (e.g., alcohols, phenols, chlorinated hydrocarbons, pyridines, ketones) from water such as in aqueous effluents or process fluids. By way of example, a membrane that is ethanol-selective could be used to increase the ethanol concentration in relatively dilute ethanol solutions (e.g., less than 10% ethanol or less than 5% ethanol or from 5 to 10% ethanol) obtained by fermentation processes. A further liquid phase separation example that is contemplated with the compositions and membranes of the present invention includes the deep desulfurization of gasoline and diesel fuels by a pervaporation membrane process (See, e.g., U.S. Pat. No. 7,048,846, which is incorporated herein by reference). Compositions and membranes of the present invention that are selective to sulfur-containing molecules could be used to selectively remove sulfur-containing molecules from fluid catalytic cracking (FCC) and other naphtha hydrocarbon streams. Further, mixtures of organic compounds that can be separated with the compositions and membranes of the present invention include ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and/or ethylacetate-ethanol-acetic acid.

In particular instances, the membranes of the present invention can be used in gas separation processes in air purification, petrochemical, refinery, natural gas industries. Examples of such separations include separation of volatile organic compounds (such as toluene, xylene, and acetone) from chemical process waste streams and from Flue gas streams. Further examples of such separations include the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the blended polymeric membranes described herein. More than two gases can be removed from a third gas. For example, some of the gas components which can be selectively removed from a raw natural gas using the membranes described herein include carbon dioxide, oxygen, nitrogen, water vapor, hydrogen sulfide, helium, and other trace gases. Some of the gas components that can be selectively retained include hydrocarbon gases. In further instances, the membranes can be used on a mixture of gases that include at least 2, 3, 4, or more gases such that a selected gas or gases pass through the membrane (e.g., permeated gas or a mixture of permeated gases) while the remaining gas or gases do not pass through the membrane (e.g., retained gas or a mixture of retained gases).

Additionally, the membranes of the present invention can be used to separate organic molecules from water (e.g., ethanol and/or phenol from water by pervaporation) and removal of metal (e.g., mercury(II) ion and radioactive cesium(I) ion) and other organic compounds (e.g., benzene and atrazene) from water.

A further use of the membranes of the present invention includes their use in chemical reactors to enhance the yield of equilibrium-limited reactions by selective removal of a specific product in an analogous fashion to the use of hydrophilic membranes to enhance esterification yield by the removal of water.

The membranes of the present invention can also be fabricated into any convenient form such as sheets, tubes, spiral, or hollow fibers. They can also be fabricated into thin film composite membranes incorporating a selective thin layer that has been UV- and thermally-treated and a porous supporting layer comprising a different polymer material.

Table 1 includes some particular non-limiting gas separation applications of the present invention.

TABLE 1

| Gas Separation | Application |
|---|---|
| O₂/N₂ | Nitrogen generation, oxygen enrichment |
| H₂/hydrocarbons | Refinery hydrocarbon recovery |
| H₂/CO | Syngas ratio adjustment |
| H₂/N₂ | Ammonia purge gas |
| CO₂/hydrocarbon | Acid gas treating, enhanced oil recovery, landfill gas |
| | upgrading, pollution control |
| H₂S/hydrocarbon | Sour gas treating |
| H₂O/hydrocarbon | Natural gas dehydration |
| H₂O/air | Air dehydration |
| Hydrocarbons/air | Pollution control, hydrocarbon recovery |
| Hydrocarbons from | Organic solvent recovery, monomer recovery |
| process streams | |
| Olefin/paraffin | Refinery |

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### General Details

All reagents and solvents were obtained from Sigma-Aldrich® (U.S.A.) and used without further purification. X-ray diffraction (XRD) patterns were measured from a Bruker D8 Advance X-ray Diffractometer with CuKα radiation λ=0.154056 nm. Scanning electron microscopy (SEM) images were obtained from a scanning electron microscope (SEM, Quantum 600, FEI) operating at 10 kV. The specific surface area and pore size of as synthesized ZIF-8 particles were analyzed using Brunauer Emmet and Teller (BET) and HK nitrogen gas adsorption and desorption methods (ASAP 2020, Micromeritics, USA). Prior to the measurement, the sample was degassed at 120° C. for 24 hours under vacuum. NMR spectra were recorded with a Bruker AVANCE-III 400 MHz spectrometer in deuterated chloroform with tetramethyl silane as an internal standard. Fourier transform infrared spectra (FT-IR) were acquired using a NICOLET-6700 FT-IR spectrometer.

### Example 1

### Synthesis of 1,1′-Oxybis(4-azidobenzene)

4,4′-oxydianiline (4 g, 20 mmol) was dissolved in water (20 mL) containing concentrated HCl (11 mL, 37%), cooled to 0° C., and then treated drop wise with a solution of sodium nitrite (3.45 g, 50 mmol) in water (12 mL). After the addition, the reaction was maintained at 0-5° C. for 1.5 h. To the resultant clear solution was added sodium azide (3.2 g, 5 mmol) in water (12 mL). The solution was stirred for 15 min. The resulted solid was collected and washed with water. A pale yellow solid was obtained by recrystallization from ethanol. Yield=80%. The resulting solid was characterized by ¹H-NMR (CDCl₃): δ 7.0 (s, 8H) and ¹³C-NMR (CDCl₃): δ 154.3 (2C), δ 135.1 (2C), δ 120.1 (8C) and confirmed to be 1,1′-oxybis(4-azidobenzene).

### Example 2

### Synthesis of ZIF-8 Particles

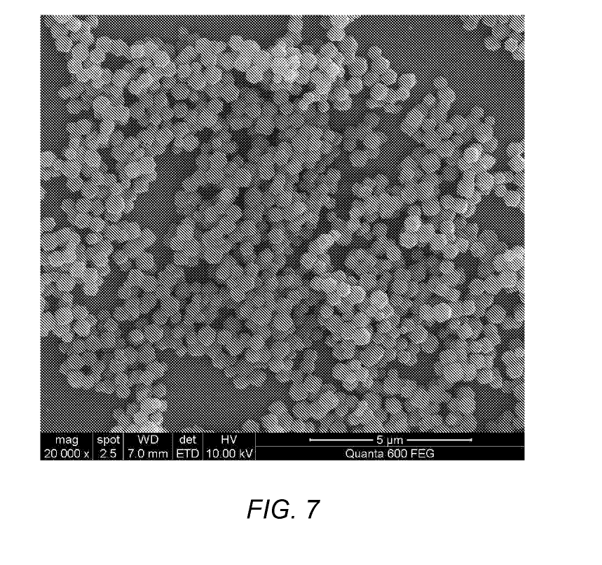

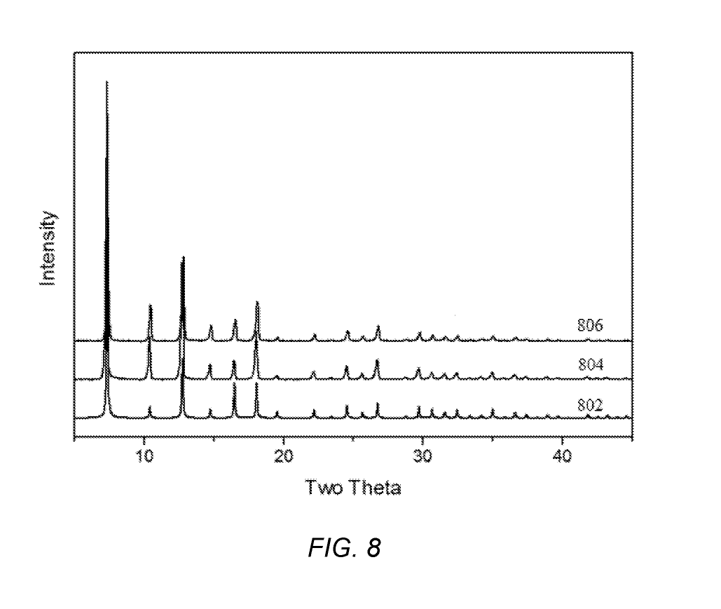

A solution of Zn(NO₃)₂.6H₂O (5 g, 16.8 mmol) in 100 mL of methanol was rapidly poured into a solution of 2-methylimidazole (12 g, 146.2 mmol) in 100 mL of methanol under stirring. The mixture slowly turned turbid and after 3 h the particles were separated from the milky dispersion by centrifugation and washed 3 times with fresh methanol. The particles were dried at 100° C. under vacuum. The particle size was about 500 nm. FIG. 7 is a scanning electron microscope image of the ZIF-8 particles. The structure of the ZIF-8 structure was confirmed by XRD by comparison of XRD pattern to a simulated ZIF-8 XRD pattern. FIG. 8 are an XRD patterns of the simulated ZIF-8 (pattern 802), synthesized ZIF-8 (pattern 804), and the ZIF-8 functionalized with the diazide of Example 1 (pattern 806). The BET surface area of the particles was determined to be about 1765.1 m²/g.

### Example 3

### Synthesis of Polyimide 6FDA-DAM

To a 250 mL of three-neck round flask, 4,4′-(Hexafluoroisopropylidene)diphthalic anhydride (10 mmol) and 3,6-diaminodurene (10 mmol) was dissolved in anhydrous N-Methyl-2-pyrrolidone (NMP, 30 mL) and stirred for 24 h under N₂ atmosphere. Acetic anhydride (226.6 mmol) and pyridine (11.55 mmol) were added to the reaction mixture, and the mixture was stirred for 48 h. The resulting polymer was precipitated by pouring the solution into methanol. The precipitation process was repeated 2 times. A white polymer was isolated and dried at 120° C. under vacuum for 48 h. ¹H-NMR (400 MHz, CDCl₃): δ 8.12 (s, 2H), 8.00 (s, 4H), 7.29 (s, 1H), 2.27 (s, 6H), 2.03 (s, 3H). Molecular weight: Mₙ=3.16×10⁴ g·mol⁻¹, PDI=2.15.

### Example 4

### Modification of ZIF-8 Particles with Azide

ZIF-8 (1 g, Example 2) and 1,1′-oxybis(4-azidobenzene) (0.1 g, Example 1) were mixed in CH₂Cl₂ (5 mL) by stirring. The solvent was removed at room temperature, the mixture was heated to 100° C., kept for 3 h, and then heated at 175° C. under vacuum for 12 hours. After cooled down to room temperature, the resulted powder (ZIF-8/Azide) was washed with methanol three times and the dried at 100° C. for 24 under vacuum. An XRD pattern was obtained of the azide modified ZIF-8 particles. As shown in FIG. 8, the XRD pattern was the same as the XRD patterns for the ZIF-8 particles and the ZIF-8 simulated pattern. Thus, the crystal structure of modified ZIF-8 was unchanged by modification with the diazide. The BET surface area of ZIF-8/Azide was determined to be about 903.1 m²/g.

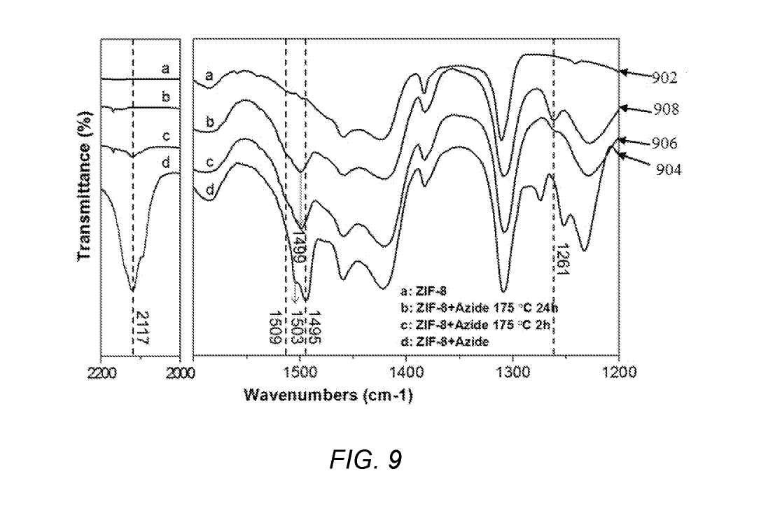

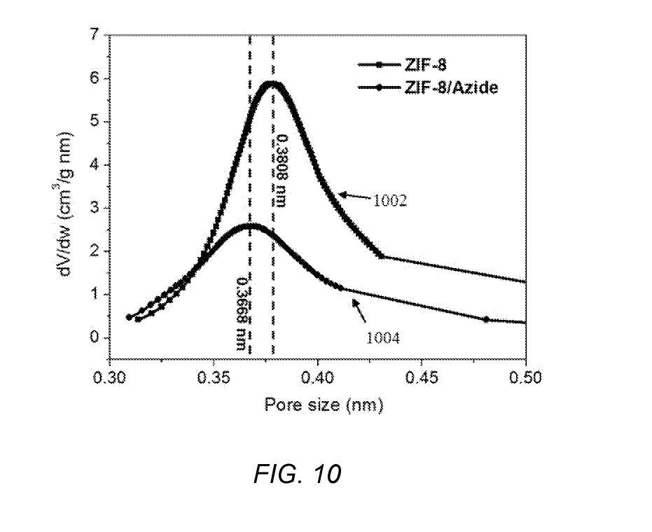

The reaction was monitored by FT-IR. FIG. 9 are Fourier-Transform infrared (FT-IR) spectra of ZIF-8 and spectra of mixtures of ZIF-8 and 1,1′-oxybis(4-azidobenzene) at room temperature, at 175° C. for 2 h, and at 175° C. for 24 h are depicted. Spectra 902 is ZIF-8, spectra 904 is ZIF-8 and 1,1′-oxybis(4-azidobenzene) at room temperature, spectra 906 is ZIF-8 and 1,1′-oxybis(4-azidobenzene) at 175° C. for 2 h, and spectra 906 is ZIF-8 and 1,1′-oxybis(4-azidobenzene) at 175° C. for 24 h. Referring to FIG. 9, the transmittance peak at 2117 cm⁻¹ in spectra 902 is due to the asymmetric stretching vibration of the nitrene (—N₃) group. As shown in spectra 904, this peak decreased when heated at 175° C. for 2 h and disappeared when the heating time prolonged to 24 h as shown in spectra 906. The disappearance of the nitrene stretching provided evidence for the formation of the nitrene intermediate and its subsequent reaction, with imidazole ligand of ZIF-8. Referring to spectra 902-906, the doublet peaks at 1495 cm⁻¹ and 1503 cm⁻¹ of the azide (spectra 902) transformed into a single peak at 1499 cm⁻¹ in ZIF-8/Azide when heated (spectra 904 and 906). Transformation of the doublet indicated a change in the chemical functionalities. Referring to spectra, 904 and 906, the heating resulted in the appearance of two peaks at 1509 cm⁻¹ and 1261 cm⁻¹. The shoulder peak at 1509 cm⁻¹ was representative of the N—H deformation vibration of secondary amines. The peak at 1261 cm⁻¹ appeared and increased with the heating time (i.e., the peak at 1261 cm⁻¹ in spectra 906 is more visible than the peak at 1261 cm⁻¹ in spectra 904). The peak at 1261 cm⁻¹ was attributed to the stretching vibration of C—N, which indicated that a secondary amine was formed. The pore size distribution of the ZIF-8/Azide was compared to the pore size distribution of ZIF-8. FIG. 10 depits the pore size distribution of ZIF-8 (data line 1002) and ZIF-8/Azide (data line 1004). As shown in to FIG. 10, the pore size of ZIF-8 was around 0.3808 nm (data line 1002) and 0.3668 nm for ZIF-8/Azide (data line 1004). A reduction in the pore size distribution indicated that the pore size of ZIF-8 and other MOFs are tunable by post-functionalization using nitrene intermediates.

### Example 5

### Preparation of Azide-Based Cross-Linked Mixed Matrix Membrane

ZIF-8 (0.2 g, Example 2) was mixed with 1,1′-oxybis(4-azidobenzene) (0.125 g, Example 1) in CH₂Cl₂ (5 mL). A solution of 6FDA-DAM polymer (0.5 g) of CH₂Cl₂ (10 mL) (filtered by 0.25 μm film) was added to this mixture, under stirring. After degassing for 45 minutes, the resulting mixture was cast in a steel ring with glass plate and the solvent was evaporated at room temperature. The resulting mixed matrix membrane was dried at 100° C. for 48 h under vacuum, and then heated at 180° C. for 12 h. The color of the membrane is changed from pale yellow to dark brown. The resulting membrane can be dissolved by CH₂Cl₂, CHCl₃, THF and DMF.

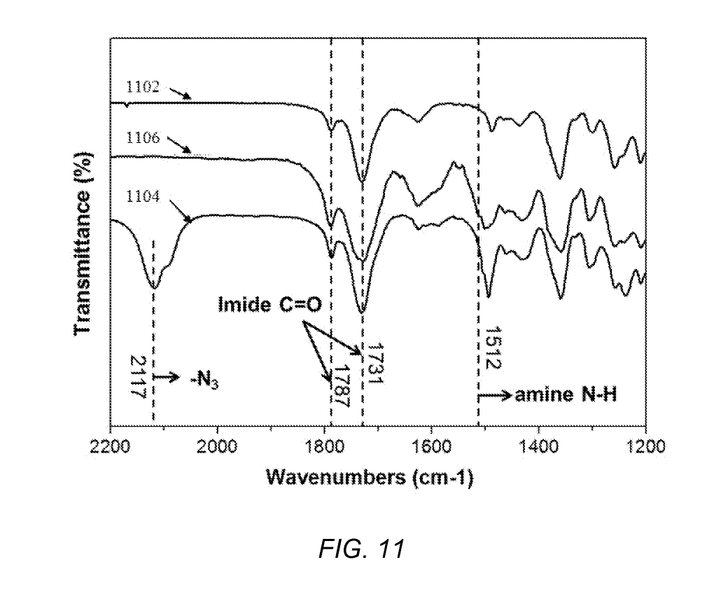

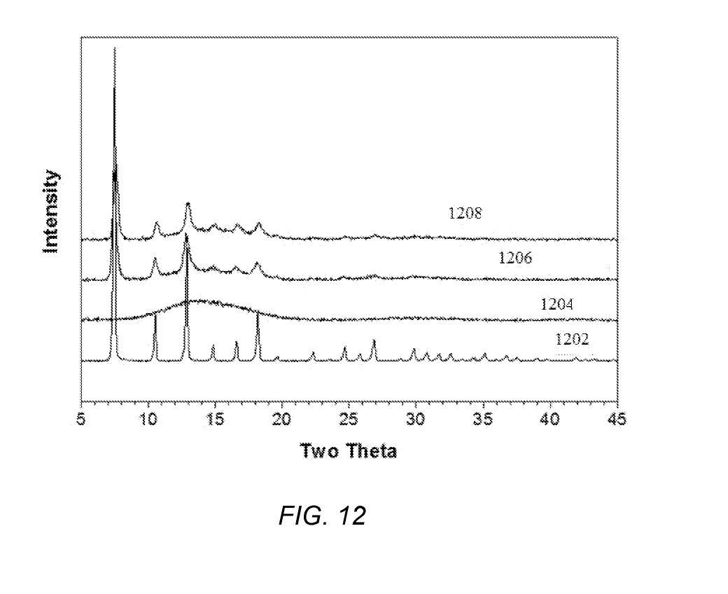

The reaction was monitored by FT-IR. FIG. 11 are Fourier-Transform infrared (FT-IR) spectra of polyimide 6FDA-DAM and spectra of mixtures of ZIF-8 and 1,1′-oxybis(4-azidobenzene) and polyimide 6FDA-DAM at 48 h at 120° C. and 12 h at 180° C. Referring to FIG. 11 the FT-IR spectra of polyimide 6FDA-DAM (spectra 1102), mixed matrix membrane 6FDA-DAM/ZIF-8/Azide (spectra 1104) at 120° C. and the cross-linked mixed matrix membrane 6FDA-DAM/ZIF-8/Azide ZIF-8 (spectra 1106) after 12 h at 180° C. are depicted. The peaks at 1787 cm⁻¹ and 1731 cm⁻¹ were characteristic peaks of polyimide carbonyl group. The peak at 2117 cm⁻¹ was attributed to the asymmetric stretching vibration of the nitrene (—N₃) group of the azide. The 2117 cm⁻¹ peak disappeared when the solution was heated at 185° C. for 12 h (spectra 1106), which resulted in the formation of cross-linked mixed matrix membrane. The FT-IR provided evidence for the formation of nitrene and its subsequent reaction with imidazole ligand of ZIF-8 and polyimide. When compare the FT-IR spectra of ZIF-8/Azide (See, FIG. 9, spectra 902), the heating treatment results in the appearance of a peaks at 1512 cm⁻¹. The peak is representative of the N—H deformation vibration of secondary amines. The membrane was characterized using X-ray diffraction. FIG. 12 depicts the XRD patterns of ZIF-8 (pattern 1202), polyimide (1204) mixed matrix polymeric material (ZIF-8 and 1,1′-oxybis(4-azidobenzene) and polyimide 6FDA-DAM prior to heating at 180° C. (pattern 1206), and cross linked mixed matrix polymeric material of the present invention (pattern 1208). Comparing pattern 1202 to patterns 1206 and 1208, it can be seen that the crystal structure of ZIF-8 was unchanged after heating at 180° C. for 12 h. This indicated that the ZIF-8 particles in the mixed matrix membrane were stable under the cross-linking reaction conditions.

### Example 6

### Permeation and Separation Properties of Polymer, Polymer/ZIF-8/Azide and Cross-Linked Polymer/ZIF-8/Azide

The gas transport properties were measured using the variable pressure (constant volume) method. Ultrahigh-purity gases (99.99%) were used for all experiments. The membrane is mounted in a permeation cell prior to degassing the whole apparatus. Permeant gas is then introduced on the upstream side, and the permeant pressure on the downstream side is monitored using a pressure transducer. From the known steady-state permeation rate, pressure difference across the membrane, permeable area and film thickness, the permeability coefficient is determined (pure gas tests). The permeability coefficient, P[cm³ (STP)·cm/cm²·s·cmHg], is determined by the following equation:

$$P = \frac{1}{760} \times \frac{V}{A} \times \frac{273}{273 + T} \times \frac{L}{760 p} \times \frac{dp}{dt}$$

where A is the membrane area (cm²), L is the membrane thickness (cm), p is the differential pressure between the upstream and the downstream (MPa), V is the downstream volume (cm³), R is the universal gas constant (6236.56 cm³·cmHg/mol·K), T is the cell temperature (° C.), and dp/dt is the permeation rate.

The gas permeabilities of polymer membranes are characterized by a mean permeability coefficient with units of Barrer. 1 Barrer=10⁻¹⁰ cm³ (STP)·cm/cm²·s·cmHg. The gas permeability coefficient can be explained on the basis of the solution-diffusion mechanism, which is represented by the following equation:

P=D×S

where D (cm²/s) is the diffusion coefficient; and S (cm³ (STP)/cm³·cmHg) is the solubility coefficient.

The diffusion coefficient was calculated by the time-lag method, represented by the following equation:

$$D = \frac{{L}^{2}}{6 θ}$$

where θ (s) is the time-lag. Once P and D were calculated, the apparent solubility coefficient S (cm³(STP)/cm³·cmHg) may be calculated by the following expression:

$$S = \frac{P}{D}$$

In gas separation, the membrane selectivity is used to compare the separating capacity of a membrane for 2 (or more) species. The membrane selectivity for one component (A) over another component (B) is given by the ratio of their permeabilities:

$${α}_{A / B} = \frac{{P}_{A}}{{P}_{B}} \vert Normal \vert ZZMPTAG \vert$$

Selectivity obtained from ratio of pure gas permeabilities is called the ideal membrane selectivity or the ideal permselectivity. This is an intrinsic property of the membrane material. The ideal selectivity of a dense membrane for gas A to gas B is defined as follows:

$$α = \frac{{P}_{A}}{{P}_{B}} = \frac{{D}_{A}}{{D}_{B}} * \frac{{S}_{A}}{{S}_{B}}$$

Permeability and ideal selectivity data for the produced membranes as compared to the polymer and a polymer-ZIF-8 membrane is provided in Tables 2 and 3, respectively.

TABLE 2

| | Thickness | Test | Permeability (Barrer) | | | | | |
|---|---|---|---|---|---|---|---|---|
| Sample | (μm) | condition | N₂ | CH₄ | H₂ | C₃H₆ | C₃H₈ | CO₂ |
| 6FDA-DAM/ | 107 | 22° C., | 337.11 | 312.49 | 4182.43 | 293.88 | 29.21 | 4141.93 |
| ZIF-8/AZIDE | | 2 Bar | | | | | | |
| Cross-linked 6FDA- | 107 | 22° C., | 31.83 | 22.15 | 915.23 | 14.16 | 0.68 | 657.35 |
| DAM/ZIF8/AZIDE | | 2 Bar | | | | | | |

TABLE 3

| | Ideal Selectivity | | | | | |
|---|---|---|---|---|---|---|
| Sample | C₃H₆/C₃H₈ | H₂/C₃H₈ | H₂/N₂ | H₂/CH₄ | CO₂/CH₄ | CO₂/N₂ |
| 6FDA-DAM/ZIF-8/AZIDE | 10.06 | 143.17 | 12.41 | 13.38 | 13.25 | 12.29 |
| Cross-linked 6FDA- | 20.75 | 1341.64 | 28.75 | 41.32 | 29.68 | 20.65 |
| DAM/ZIF8/AZIDE | | | | | | |

1. A method of modifying a metal-organic framework (MOF), the method comprising:
(a) heating a mixture comprising an azide compound and a MOF to generate a nitrene compound and nitrogen (N₂) from the azide compound; and
(b) covalently bonding the nitrene compound to the MOF to obtain the modified MOF.

2. The method of claim 1, wherein the mixture is heated to 100° C. to 250° C. for 1 hour to 24 hours.

3. The method of claim 1, wherein the MOF is a zeolitic imidazolate framework (ZIF), preferably a ZIF-8.

4. The method of claim 3, wherein the nitrene compound covalently attaches to the imidazole of the ZIF.

5. The method of claim 4, wherein the imidazole of the ZIF is a methyl imidazole carboxyaldehyde, a methyl imidazole, or a combination thereof.

6. The method of claim 5, wherein the imidazole is a methyl imidazole and the nitrene compound covalently attaches to the methyl group of the methyl imidazole.

7. The method of claim 1, wherein the azide compound is a diazide, preferably, 4,4′-diazidodiphenyl ether, more preferably, a mono-azide.

8. The method of claim 1, wherein a weight ratio of the MOF to the azide compound in the mixture is from 99.5 to 1, preferably from 50 to 20.

9. The method of claim 1, wherein the mixture further comprises a solvent, wherein the MOF and the azide compound are solubilized in the solvent, and wherein the solvent is removed prior to or during the heating step.

10. The method of claim 1, wherein the modified MOF is subsequently dried.

11. The method of claim 1, wherein the produced modified (MOF) is subsequently mixed with a polymer or polymer blend to produce a mixed matrix polymeric material.

12. The method of claim 1, wherein the mixture further comprises a polymer or polymer blend, wherein the nitrene compound attaches to the MOF and to the polymer to form a cross-linked mixed matrix polymeric material.

13. The method of claim 12, wherein the polymer is a polymer of intrinsic microporosity (PIMs), a polyetherimide (PEI) polymer, a polyetherimide-siloxane (PEI-Si) polymer, or a polyimide (PI) polymer, or blends thereof, preferably, a polyimide or blend thereof, more preferably the polyimide is 6FDA-Durene or 6FDA-DAM, most preferably 6FDA-DAM.

14. The method of claim 13, wherein the mixture comprises, by weight, from 95% to 50% of the polymer, from 1% to 20% of the azide compound, and from 4% to 30% of the MOF.

15. The method of claim 14, wherein the mixture further comprises a solvent, and wherein the polymer, the MOF, and the azide compound are solubilized in the solvent.

16. The method of claim 15, wherein the azide compound is 4,4′-oxybis(azido)benzene, the polymer is 6FDA-DAM and the MOF is ZIF-8.

17. The method of claim 16, wherein the polymeric material is characterized by FT-IR peaks at 1787 cm⁻¹ and 1731 cm⁻¹.

18. The method of claim 10, further comprising forming the mixed matrix polymeric material into a thin film membrane, a flat sheet membrane, a spiral membrane, a tubular membrane, or a hollow fiber membrane and wherein the mixed matrix polymeric material is substantially void-free or a majority of the voids in the membrane are 5 or less Angstroms in diameter.

19. A modified metal-organic framework (MOF) or a mixed polymeric material produced by the method of claim 1.

20. A thermally treated cross-linked mixed matrix polymeric material comprising a polyimide containing polymeric matrix and metal-organic frameworks (MOFs), wherein the MOFs are attached to the matrix through a dinitrene cross-linking compound that covalently binds to the polyimides and to the MOFs.
